(19) United States
(12) Patent Application Publication
(10) Pub. No.: US 2010/0294717 A1
(43) Pub. Date: Nov. 25, 2010

(54) POST TREATMENT FOR DESALINATED AND SOFT WATER FOR BALANCED WATER COMPOSITION SUPPLY

(75) Inventors: Ori Lahav, Nesher (IL); Liat Birnhack, Nesher (IL); Malka Kochva, Haifa (IL); Roni Penn, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: TECHNION RESEARCH & DEVELOPMENT FOUNDATION LTD., Haifa (IL)

(21) Appl. No.: 12/446,393

(22) PCT Filed: Oct. 21, 2007
(86) PCT No.: PCT/IL07/01261

§ 371 Date: Apr. 20, 2009

(30) Foreign Application Priority Data
Oct. 22, 2006 (IL) 178800

(51) Int. Cl. C02F 9/04; C02F 1/42; C02F 1/44; C02F 1/66; C02F 1/68

(52) U.S. Cl. 210/638; 210/687; 210/677; 210/669; 210/672; 210/190; 210/170.11

(57) ABSTRACT

An H2S04-based calcite dissolution post-treatment process and apparatii for desalinated water are provided. The process comprises separating cations from seawater by ion exchange resin (s) (12) onto which the ions are loaded, contacting the ion exchange resin (s) (12) loaded with the cations with an effluent (1) of a calcite dissolution reactor (10) wherein the cations are exchanged with Ca2+ from this effluent. The Ca2+ concentration of the resulting desalinated water (6) decreases while the cations concentration increases to comply with required quality criteria. Batch type and continuous apparatii by which the process can be carried out are described.

### FIELD OF THE INVENTION

The present invention relates to desalinated and soft waters. More particularly, the present invention relates to post treatment of desalinated water and soft water for supply of balanced water composition.

### BACKGROUND OF THE INVENTION

Desalination of seawater and brackish water is receiving increased attention worldwide. It is expected that the percentage of desalinated water out of the total water supply in many countries will increase significantly in the near future. There are two types of industrial desalination processes: reverse osmosis (RO) technology and electro-dialysis technologies. Both processes result in water that is very low in dissolved solids. Naturally occurring soft waters are also encountered in many places. In order to improve the quality of these water sources, treatment is needed (in desalinated water, the water is treated following the membrane separation step and is thus termed “post treatment”). Water low in dissolve substances tastes insipid, but more importantly, it tends to be corrosive to water distribution pipes, which are typically made of metal. Corrosion of metal pipes results in both shortened infrastructure life time and also in a constant release of dissolved metal ions and colloid metal particles into the water, and therefore to the consumer's tap. In order to be able to use the water as drinking water, soft waters and effluent from desalination plants has to be treated to stabilize the water. Additionally, in most places, drinking water is expected to supply certain minerals that are essential for human health, e.g. Ca²⁺ and Mg²⁺ ions, and agricultural irrigation supplements such as Ca²⁺, Mg²⁺ and SO₄²⁻ ions. In some occasions, the total hardness of the water (i.e. the sum of [Mg²⁺] and [Ca²⁺]) may also be limited due to economic reasons.

Desalinated water is invariably required to be post treated (“Larnaca Desalination Plant”, by B. Liberman in Desalination 138 (2001), 293-295) to comply with a certain, required, chemical quality; However, to date, no formal regulation exists worldwide that defines unequivocally the quality of desalinated water. However, the water is expected to conform to the general water quality requirements. In Israel, the following set of quality criteria for desalinated water was adopted in January 2006 by the Committee for the Update of Israel's water regulations nominated by the Israeli Ministry of Health (the criteria, unique in the world, are expected to come into effect in the near future):

| | |
|---|---|
| 1. | Alkalinity (H₂CO₃* alkalinity) > 80 mg/L as CaCO₃ |
| 2. | 80 < Ca²⁺ < 120 mg/L as CaCO₃ |
| 3. | 3 < CCPP* < 10 mg/L as CaCO₃ |
| 4. | pH < 8.5 |

*CCPP stands for Calcium Carbonate Precipitation Potential

The choice of post-treatment process to be applied in the desalination plant is determined primarily by the water quality required and economic considerations. Two main groups of post treatment processes are typically implemented for soft waters and desalination plant effluents: (1) processes that center around CaCO₃₍ₛ₎ dissolution for both alkalinity and Ca²⁺ supply and (2) processes that are based on direct dosage of chemicals. The latter group is less often implemented because of economical reasons and will thus not be discussed further.

Calcite dissolution processes are cost effective in places where calcite abounds in nature and can be easily extracted. In order to enhance calcite dissolution kinetics, water pH must be reduced before it is introduced into the calcite reactor. Two acidic substances are typically used to lower the pH: H₂SO₄ and CO_{2(g)}. The advantage of using a strong acid such as H₂SO₄ is that pH can be lowered to any desired value, which results in rapid CaCO₃ dissolution kinetics. As a result, it is possible to pass only a fraction of the water through the calcite column, and blend it with the untreated fraction thereafter. To determine the final pH (and the final CCPP value) NaOH is dosed to the blend prior to its discharge. The process is depicted schematically in FIG. 1 that illustrates a typical calcite-dissolution-based post treatment using H₂SO₄ for pH reduction. This post treatment process is currently practiced, for example, in the 100,000,000 m³/year desalination plant in Ashkelon, Israel.

The main advantage of this method is that it requires a relatively small calcite packed bed reactor, the application of the acid is simple and inexpensive, and the process is thus relatively cheap. Disadvantages include the release of a substantial amount of SO₄²⁻ to the water (may also be considered an advantage if the water is used for agricultural irrigation), and possible gypsum precipitation. However, the most significant drawback associated with this process is that it is bound to yield a ratio of approximately 2 to 1 between the Ca²⁺ and alkalinity concentrations in the effluent, and sometimes even a higher ratio (both parameters in units of mg/L as CaCO₃). As a consequent, meeting the demand for an alkalinity concentration of >80 mg/L as CaCO₃ results in a Ca²⁺ concentration that is higher than the upper limit of 120 mg/L as CaCO₃ required by the new criteria. In other words, meeting the alkalinity value yields water that is excessively hard. Similarly, if the Ca²⁺ concentration is maintained below the upper limit (i.e. below 120 mg/L as CaCO₃), the alkalinity concentration in the effluent will be below the recommended value and the buffering capacity of the water will low, rendering the water chemically instable. Consequently, the process depicted in FIG. 1 cannot be implemented to meet the required quality criteria.

The reason for the approximate 2 (Ca²⁺) to 1 (alkalinity) ratio is as follows: to be cost effective, concentrated H₂SO₄ is typically dosed to the water to lower pH to a pH value between 2.2 and 2.5, just before the water enters the calcite reactor (see FIG. 1). The flow regime in the calcite reactor resembles vertical plug flow (either upward or downward). Along its flow through the calcite reactor CaCO₃ dissolves and the water collects both Ca²⁺ and CO₃²⁻ ions. Because of the low to neutral pH that prevails throughout the calcite reactor, CO₃²⁻ is instantaneously transformed to HCO₃⁻ and/or H₂CO₃*, and in parallel pH goes up. At the end of the process, the water leaves the calcite reactor at a pH close to 7.0. After blending with the split flow (see FIG. 1) pH is raised to the final pH (between 8.0 and 8.3) by dosage of a concentrated NaOH solution.

The result of this process is that the Ca²⁺ concentration expressed in the units “mg/L as CaCO₃” is always about twice that of the alkalinity expressed in the same units. Simply put, under these conditions, around 50% of the proton accepting capacity of the CO₃²⁻ that originates from dissolving the calcite solid is used for raising pH from the initial pH value to a pH value around 4.5 that is typically used as the end point for H₂CO₃* alkalinity determination. This proton accepting capacity is therefore not accounted for in the alkalinity determination procedure.

In the second calcite dissolution process, CO_{2(g)} is used in order to acidify the water prior to its introduction into the calcite reactor. The main advantage of the process is that the resultant Ca²⁺ to alkalinity ratio tends towards 1 to 1 (both parameters expressed in mg/L as CaCO₃) and thus both parameters can be attained at similar concentrations, which allows attaining the alkalinity and calcium criteria at the same time. The main disadvantage of this process is that CO₂ addition can reduce pH to not lower than around pH 4.0, and thus calcite dissolution kinetics are much slower than with H₂SO₄. Consequently, all (or most of) the water has to be passed through the calcite reactor, and thus much larger reactor volumes are required. Another disadvantage is that the application of the CO_{2(g)} as an acidic substance is more expensive than that of H₂SO₄. As a result, in terms of cost effectiveness, the operation of the method that uses H₂SO₄ as the acidic substance is considerably cheaper than the method that utilizes CO_{2(g)}. However, as explained before, using the process that is depicted in FIG. 1 cannot comply with the required Ca²⁺ to alkalinity ratio, a fact that endorses the use of the CO_{2(g)} based calcite dissolution process.

Another significant drawback that is associated with both calcite dissolution processes is that they result in no addition of Mg²⁺ ions to the water. Mg²⁺ ions, although not included in the current Israeli quality criteria, are very much welcome in desalinated water for both agricultural and human health reasons. Post treatment processes that are based on calcite dissolution cannot, naturally, supply Mg²⁺ ions. Other options such as dolomite rock (MgCa(CO₃)₂) dissolution or direct chemical dosage are either expensive or result in a high counter anion concentration (typically chloride ions).

### SUMMARY OF THE INVENTION

It is an object of the present invention to provide additional step(s) to the cost-effective H₂SO₄-based calcite dissolution post-treatment process that would enable its implementation along with the supply of cheap Mg²⁺ ions originating from seawater, while fully conforming to the other required criteria.

It is another object of the present invention to provide an apparatus for post-treatment of desalinated and soft waters from which the resulting water is enriched with cheap Mg²⁺ ions originating from seawater and is fully conforming to other required criteria including (if required) a threshold hardness concentration.

It is therefore provided in accordance with a preferred embodiment of the present invention an H₂SO₄-based calcite dissolution post-treatment process for desalinated water (or any other soft water) comprising:
separating Mg²⁺, (and also K⁺ and Na⁺ ions, if required) ions from natural water body by means of ion exchange resins onto which said Mg²⁺, Na⁺ and K⁺ ions are loaded; other cations can be employed as well;
contacting said ion exchange resin loaded with said ions with an effluent of a calcite reactor wherein said ions are exchanged with Ca²⁺ from said effluent;
whereby the Ca²⁺ concentration of the resulting water decreases while the Mg²⁺ concentration (and also Na⁺/K⁺, if limitation on hardness concentration is imposed) increases to comply with required quality criteria.

Furthermore in accordance with a preferred embodiment of the present invention, the process further comprises washing said ion exchange resin with an internal desalination-plant water stream low in dissolved solids.

Furthermore in accordance with another preferred embodiment of the present invention, one of the said ion exchange resins that is used in the process has a high affinity towards divalent cations such as Mg²⁺ and Ca²⁺ and an extremely low affinity towards monovalent cations such as Na⁺ and K⁺ and another ion exchange resin has a high affinity towards Na⁺ and K⁺ and a relatively low affinity towards Ca²⁺ and Mg²⁺.

Furthermore in accordance with another preferred embodiment of the present invention, the 1^{st} said ion exchange resin is a resin such as Amberlite IRC747 (Rohm & Hass INC.) or equivalent and said 2^{nd} ion exchange resin is any resin with the affinity sequence presented above.

Furthermore in accordance with another preferred embodiment of the present invention, said seawater used to load the resin with Mg²⁺ ions is filtered seawater (filtered either by sand filtration or by UF membrane filtration) before it enters the desalination process.

Furthermore in accordance with another preferred embodiment of the present invention, said seawater used to load the resin with Mg²⁺ (and Na⁺ and/or K⁺ if a limitation on hardness is imposed) is a brine stream provided from a desalination process.

Furthermore in accordance with another preferred embodiment of the present invention, said seawater that is used to load the resin is returned back to a container from where it was taken to be further used in the RO process.

Furthermore in accordance with another preferred embodiment of the present invention, said RO brine that is used to load the resin is returned back to the sea.

Furthermore in accordance with another preferred embodiment of the present invention, the ion exchange reactions are carried out in a batch ion-exchange mode.

Furthermore in accordance with another preferred embodiment of the present invention, the ion exchange reactions are carried out in a continuous ion exchange mode.

Furthermore in accordance with another preferred embodiment of the present invention, the required quality criteria that the process may produce is: Alkalinity (H₂CO₃* alkalinity) greater than 60 mg/L as CaCO₃; Ca²⁺ higher than 80 mg/L; Calcium Carbonate Precipitation Potential between 3 and 10 mg/L as CaCO₃ and pH of less than 8.5. However, the process can be used in a flexible fashion to produce different water qualities, including a limitation on total hardness of, for example, 120 mg/L as CaCO₃, while at the same time conforming to the other water quality criteria.

Furthermore in accordance with another preferred embodiment of the present invention, the process can be implemented in order to replace any certain fraction of the Ca²⁺ concentration generated by the H₂SO₄-based calcite dissolution process by an equivalent Mg²⁺, and/or K⁺ and/or Na⁺ concentration.

It is furthermore provided in accordance with yet another preferred embodiment of the present invention, a post-treatment apparatus for treating water coming out of a desalination process comprising:
at least one ion exchange column provided with one or a number of resin types wherein said resins are adapted to be loaded with Mg²⁺, Na⁺ or K⁺ ions or other cations in one or two load cycles and adapted to exchange a portion of said Mg²⁺, Na⁺ or K⁺ ions with Ca²⁺ ions in one or two exchange cycles;
a calcite reactor adapted to provide said Ca²⁺ ions that are being transferred from said calcite reactor to the said soft water and afterwards to said at least one ion exchange column in said exchange cycle;
whereby the resulting desalinated water coming out of the exchange cycle is lower in Ca²⁺ concentration and richer in Mg²⁺ (and Na⁺ and K⁺) ions (relative to the water leaving said calcite reactor) so as to comply with required quality criteria or in order to add the other cations to the water at the expense of Ca²⁺ ions.

Furthermore in accordance with a preferred embodiment of the present invention, the apparatus further comprises means adapted to wash said at least one ion exchange column and return wash water back to a point in the desalination process from which it was taken, or discard it back to the sea in a controlled and approved fashion.

Furthermore in accordance with another preferred embodiment of the present invention, effluent from said exchange cycle is recombined with raw water split flow of the desalinated water and NaOH is added to the combined flow to attain desalinated water having predetermined required pH, alkalinity, Ca²⁺, total hardness and CCPP values.

Furthermore in accordance with another preferred embodiment of the present invention, the water added with NaOH is mixed in a storage tank to yield a required water quality prior to discharge.

Furthermore in accordance with another preferred embodiment of the present invention, said ion exchange columns are continuous exchangers wherein said resins are adapted to pass between a “load zone”; a “wash zone”; and an “exchange zone” and wherein the time the resin spends in each of the zones is determined by specific required quality criteria.

Furthermore in accordance with another preferred embodiment of the present invention, the 1^{st} resin is a resin such as Amberlite IRC747 (Rohm & Hass INC.) and the 2^{nd} resin is a resin with a high affinity towards Na⁺ and K⁺ and a relatively low affinity towards Ca²⁺ and Mg²⁺.

Furthermore in accordance with another preferred embodiment of the present invention, said Mg²⁺, Na⁺ and K⁺ ions are originating from filtered seawater before it enters the desalination process or from brine provided from a desalination process.

In addition and in accordance with yet another preferred embodiment of the present invention, said filtered seawater or brine is returned back to a container from where it was taken in a closed loop manner after passing through said at least one ion exchange column.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 Schematically illustrates a typical calcite-dissolution-based desalination post treatment using H₂SO₄ for pH reduction (PRIOR ART).

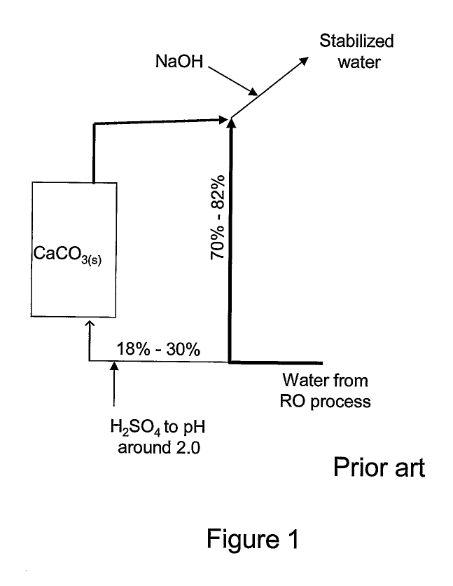

FIG. 2 Schematically illustrates a calcite-dissolution-based desalination post treatment process in accordance with a preferred embodiment of the present invention (batch ion exchange operation).

FIG. 3 Schematically illustrates a calcite-dissolution-based desalination post treatment process in accordance with another preferred embodiment of the present invention (continuous ion exchange operation).

### DETAILED DESCRIPTION OF THE INVENTION

The present invention provides a new and unique post treatment process to be used after water desalination or to be applied to naturally occurring soft waters. The present invention may be used to treat any soft water type. Desalinated water is an example for such water. The post treatment process in accordance with the present invention makes use of the most cost-effective post-treatment process (i.e. calcite dissolution using H₂SO₄), but at the same time results in a Ca²⁺ (and possibly total hardness) concentration in the effluent that complies with stringent water criteria regulations (in terms of alkalinity, CCPP and pH) and also in a significant supply of dissolved Mg²⁺ with the water, while fully conforming to the other required criteria.

Optionally, seawater as a source of cations may be replaced inland with solid salts extracted from the sea. For example, a certain salt product from the Dead Sea in Israel contains 25% Mg²⁺ by mass and can be used for this purpose.

The invention hinges around replacing the excessive Ca²⁺ ions generated in the H₂SO₄ based calcite dissolution process by Mg²⁺ (and possibly Na⁺ and K⁺ ions, if a restriction on total hardness is imposed) ions originating from seawater. First, Mg²⁺ ions are separated from natural water body such as seawater by means of an ion exchange resin that has a high affinity towards divalent cations (Mg²⁺ and Ca²⁺) and an extremely low affinity towards monovalent cations (Namely Na⁺ and K⁺). Second, the Mg²⁺-loaded resin is contacted with a certain portion of the effluent of the calcite reactor. In this step Mg²⁺ and Ca²⁺ are exchanged. Consequently, the Ca²⁺ concentration of the water decreases while the Mg²⁺ concentration increases to comply with the required quality criteria. If a restriction on total hardness is imposed, a certain Ca²⁺ portion should also be replaced with monovalent cations such as Na⁺ and K⁺. In such a case a second ion exchange resin, having a high affinity towards Na⁺ and K⁺ and a low affinity towards Ca²⁺ and Mg²⁺ is used to load Na⁺ and K⁺ from seawater (or RO brine). This resin is thereafter contacted with a certain portion of the calcite reactor effluent whereby a predetermined Ca²⁺ concentration is replaced with Na⁺ and K⁺.

All the water streams used in the ion exchange processes are preferably internal streams that form a part of the desalination plant sequence regardless of the additional ion exchange processes. For example, the stream used to load the resins with Mg²⁺, Na⁺ and K⁺ ions may be either the filtered seawater before it enters the membrane process or the brine of the 1^{st} RO desalination step. The water that is used to load the resin is returned back to the container from where it was taken (closed loop) or discarded back to the sea (in the case of brine).

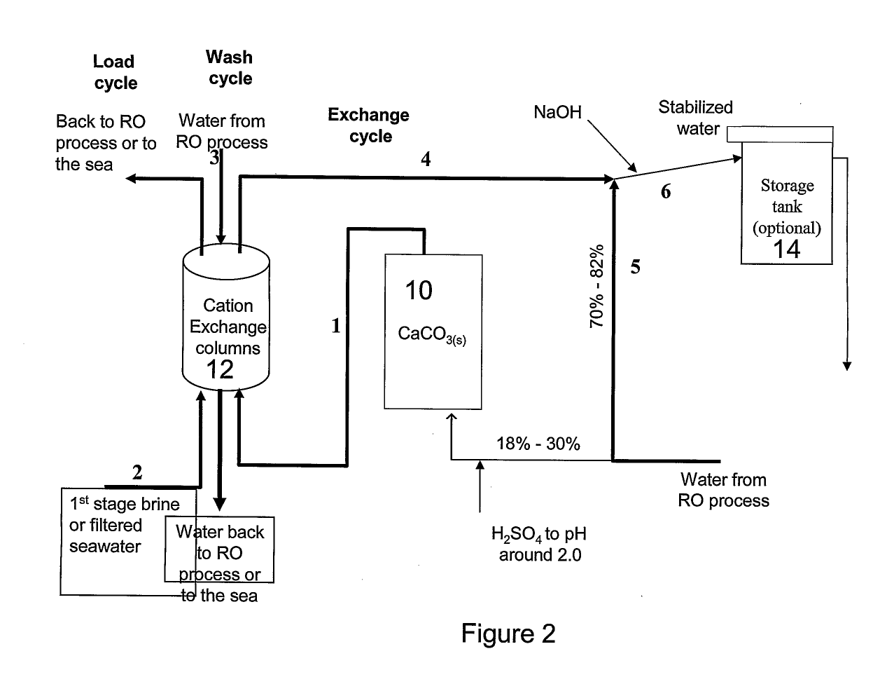

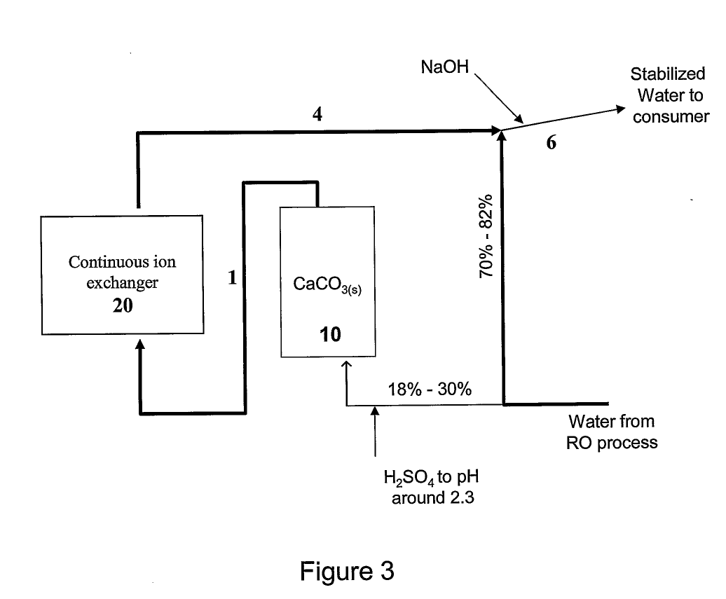

Reference is now made to FIG. 2 and FIG. 3 that schematically illustrate a calcite-dissolution post treatment process that includes an ion exchange reactor (could be also several reactors filled with one or more resin types) in accordance with a preferred embodiment of the present invention. The process in accordance with the present invention can be carried out in either a batch mode as illustrated in FIG. 2 or in a continuous mode as illustrated in FIG. 3. Batch mode operation (which is by definition a non steady state operation) may be preferred in cases where the desalinated water is stored in a sufficiently large downstream storage tank prior to discharge, where the product water is mixed, or when multiple columns are used and timed in such a way to produce a close to constant water quality product with time. Alternatively, when no storage exists, the preference may be to apply a continuous ion exchange process (i.e. steady state operation) that allows for the discharge of water with quality parameters that do not change with time.

A simplified scheme of exemplary batch operation mode is depicted in FIG. 2. In the batch operation mode, a number of ion exchange columns are operated intermittently (classical ion exchange operation), i.e. a control system is used to switch the columns' mode between an Exchange mode, a Load mode and a Wash mode. During the Exchange mode, Ca²⁺ ions from the water flowing from a calcite reactor 10 (the stream is indicated by #1 in FIG. 2) are exchanged with Mg²⁺ (and Na⁺ or K⁺, if required) ions from a resin that is placed within a cation exchange column 12. In the Load mode, seawater or, alternatively, the brine from the 1^{st} RO stage that is more concentrated than seawater (indicated by stream #2) is used to load fresh Mg²⁺ (Na⁺, K⁺) ions onto the resins in cation exchange column 12. In the Wash mode, which is the shortest mode, brine water low in dissolved solids (stream #3) (from the desalination process) is used to wash the resin from residual loading solution (either seawater or RO brine). The additional average salinity added to the product water (in the Exchange mode that follows the Wash mode) due to residual water from the Load mode would not exceed a Total Dissolved Solids (TDS) value of approximately 5 mg/L and the boron concentration addition due to the wash step should not exceed a value of 0.1 mg/L. Following the Wash mode, the wash water is pumped back to the point in the RO process from which it was taken or discarded back to the sea. The effluent from the Exchange mode (stream #4), is recombined with the split flows (either raw desalinated water alone, or a combination of raw desalinated water and calcite reactor effluent) (indicated by #5), and NaOH is added to the combined flow to attain the required pH and CCPP values. In order to avoid irregularity in water quality (due to the unsteady state nature of the batch ion exchange operation), the effluent of the process (indicated by stream #6), may be mixed in a storage tank 14 to yield the required water quality prior to discharge, or alternatively multiple ion exchange columns are operated in a controlled manner as to produce a close to constant water quality.

Reference is now made to FIG. 3 illustrating a continuous ion-exchange operation in accordance with a preferred embodiment of the present invention. In the term “continuous ion exchange process” are included all possible technical alternatives of such technology (e.g. CSTR reactors with gravity resin separation, rotary continuous systems, patented systems such as Calgon's ISEP® Continuous Contactor, and equivalents) in which the steps: ion exchange, wash, and regeneration are carried out simultaneously, and effluent quality is thus constant in time. In the current invention the resin passes periodically between three distinct zones: a “load zone”; a “wash zone”; and an “exchange zone”. The time the resin spends in each zone is determined according to the specific requirements of the process, but typically the resin will remain in the Exchange zone for about 85% of the time, in the Load zone for about 10% of the time, and in the Wash zone for about 5% of the time. In the “Load zone”, filtered seawater (or brine from the desalination plant whose concentration is higher than seawater) is passed through a specific cationic ion exchange resin 20 and Mg²⁺ (and Na⁺ or K⁴) ions from the seawater are absorbed onto the resins. The water that serves to load the resins is returned back to the RO process or discarded to the sea as originally planned in the RO process, thus no further waste is generated.

After leaving the Load zone, the resin passes on to the Wash zone in which it is washed by water low in TDS originating from the desalination process (e.g. the brine of one of the RO process stages that has a relatively low salinity, for example the brine from the 2^{nd} or 4^{th} stage in the Ashkelon desalination plant). After washing the resin, the wash water is returned to the RO process, thus again no waste is generated. The time that the resin spends in the wash zone (and the washing water flow rate) is planned in such a way that the salinity added to the product water due to water remaining in the bed that originated from the Load zone would not exceed an average Total Dissolved Solids (TDS) value of approximately 5 mg/L. The resin that leaves the Wash zone is conveyed to the “Exchange zone” to which the effluent of the calcite dissolution process is pumped. In this zone the surplus dissolved Ca²⁺ ions generated in the calcite dissolution process are exchanged (equivalent per equivalent) with Mg²⁺, Na⁺ or K⁺ ions adsorbed on the resins (see example below). The water that leaves the Exchange zone is recombined with the split soft water stream to yield the final required Ca²⁺, Mg²⁺, and hardness (if required) concentrations. Finally, NaOH is dosed to the combined stream to attain a required pH (and CCPP) value.

There are two main advantages to the modification of the H₂SO₄ calcite dissolution process that is suggested in the invention: the addition of the ion exchange part allows using this process (which is much cheaper than the alternatives) without surpassing the Ca²⁺ concentration limit set by the new criteria. At the same time the process allows the supply of cheap Mg²⁺ ions to the water, and also the supply of water that is not excessively hard. Furthermore, the process generates no waste streams since all the water required to both load the resin and wash it comes from within the RO process and returns to it without inversely affecting the membrane separation process itself.

### Examples Related to the Operation of the Process:

The following examples demonstrate how to attain two different sets of required water quality criteria using the proposed process. In the first example it is assumed that a continuous ion exchange mode is used. In the second example multiple column operation (stationary resin) is assumed. Multiple column operation is, in principal, similar to continuous operation, apart from the fact that the resin is stationary (it is subjected periodically to three different water streams in the Exchange, Load and Wash cycles) and the water quality that leaves the post treatment process is not constant with time. A constant and average water quality can be attained by either installing a downstream storage tank, or in case the water flow rate is large, multiple ion exchange columns can be used, operated gradually with time. In the latter case the effluent streams from the columns are combined together in order to attain a final water quality with predetermined fluctuations in quality parameters' concentrations.

Note that in these two specific examples the water quality requirements do not include a restriction on the total hardness concentration. If such a restriction is imposed a second ion exchange resin should be installed with the aim of replacing excess Ca²⁺ ions with Na⁺ and/or K⁺ ions.

### Operational Parameters Related to the Examples:

Flow rate of RO desalination plant=14,000 m³/hr (equivalent to the typical operative flow rate of a plant designed to supply 100,000,000 m³/year).

Total dissolved solids concentration in the water originating from the membrane separation process=30 mg/L.

Fraction of raw water that passes through the calcite reactor=25%.

Temperature=20° C.

CCPP assumed at the outlet of the calcite reactor=−10 mg/L as CaCO₃.

In these examples it was assumed that the post treatment reactors are sealed from the atmosphere, and therefore no release of CO₂ from the water to the atmosphere occurs.

### Example 1

### Continuous-Mode Operation

### Required Water Quality at Outlet of Post Treatment Process

Alkalinity>90 mg/L as CaCO₃

120>[Ca⁺]≧80 mg/L as CaCO₃

[Mg²⁺]=24.3 mg/L as Mg²⁺

CCPP≧3.0 mg/L as CaCO₃

pH=<8.5

### General Design

The required chemicals addition to the water when it passes through the calcite reactor is (assuming that only 25% of the water passes through the calcite reactor the chemical dosage per m³ of product water is 25% of these values):

H₂SO₄ (100%)=487 mg/L (to pH 2.06)

CaCO₃₍ₛ₎=760 mg/L

According to the existing calcite dissolution process, this stream should have been recombined with 75% of untreated water and NaOH added to attain a pH value of around 7.8 to yield the following results: Alkalinity=92.5 mg/L as CaCO₃, [Ca²⁺]=190 mg/L as CaCO₃, and CCPP=3.2 mg/L as CaCO₃ (the NaOH dosage required in this scenario is 21.4 mg/L).

In the suggested process, the water that leaves the calcite column has the following water quality parameters: Alkalinity=263 mg/L as CaCO₃, Ca²⁺=760 mg/L as CaCO₃, pH=6.64. This water is pumped into the “exchange zone” and is contacted with the resin so that 8 meq/L of CaCO₃ (i.e. 2 meq/L or 100 mg/L as CaCO₃ in the final product water after it is recombined with the split stream; see FIG. 3) are replaced by 8 meq/L of Mg²⁺ (i.e. following a 4:1 dilution [Mg²⁺]=2 meq/L or 24.3 mg Mg²⁺/L in the final product water).

The resulting water composition (following the blend with the split raw water stream (see FIG. 3), and NaOH dosage of 23.7 mg/L) is: Alkalinity=95.4 mg/L as CaCO₃, [Ca²⁺]=90 mg/L as CaCO₃, [Mg²⁺]=24.3 mg/L, pH=8.18, and CCPP=3.2 mg/L as CaCO₃.

Estimation of the Volume of Resin Required in the Continuous Ion Exchange Process (according to the requirements presented in the Example)

Using the specific resin Amberlite IRC747 (Rohm & Hass INC.), the hydraulic retention time required in the Exchange zone is between 1.5 and 2 minutes (i.e. 30 to 40 bed volumes per hour—manufacturer's data). Assuming that the flow rate into the calcite reactor is 3500 m³/h (25% of the hourly peak flow rate of a 100,000,000 m³/year desalination plant), the volume of resin in the Exchange zone should be around 100 m³ (3500 m³/h divided by 35 BV/h).

The volume of the resin in the “Load” zone is, under the conditions of this example, 15% to 20% of the volume in the “Exchange zone” (i.e. up to 20 m³).

The volume of the resin in the “Wash” zone in the example is expected not to exceed 10 m³.

In total the volume of resin required under the conditions described in the example is up to 130 m³.

### Example 2

### Multiple Column Operation

### Required Water Quality at Outlet of Post Treatment Process

Alkalinity≧65 mg/L as CaCO₃

120>[Ca²⁺]≧80 mg/L as CaCO₃

[Mg²⁺]=12.15 mg/L

CCPP≧2.0 mg/L as CaCO₃

pH<8.5

### General Design

The required chemicals addition to the water when it passes through the calcite reactor is (assuming that only 25% of the water passes through the calcite reactor, the chemical dosage to the overall water flow is one fourth of the dosage stated herein):

H₂SO₄ (100%)=316 mg/L (to pH 2.24)

CaCO₃₍ₛ₎=525 mg/L

According to the existing calcite dissolution process, this stream should have been recombined with 75% of untreated water and NaOH added to attain a pH value of around 8.2 to yield the following results: Alkalinity=66 mg/L as CaCO₃, [Ca²⁺]=132 mg/L as CaCO₃, and CCPP=3.0 mg/L as CaCO₃ (the NaOH dosage required in this scenario is 12.3 mg/L).

In the suggested process, the water that leaves the calcite column (with the following water quality parameters: Alkalinity=202.5 mg/L as CaCO₃, Ca²⁺=525 mg/L as CaCO₃, pH=6.83) is pumped into the ion exchange columns and is contacted with the resin so that 4 meq/L of CaCO₃ (i.e. 1 meq/L or 50 mg/L as CaCO₃ in the final product water after it is recombined with the split stream; see FIG. 3) are replaced by 4 meq/L of Mg²⁺ (i.e. 1 meq/L or 12.15 mg Mg²⁺/L in the final product water).

The resulting water composition (following the blend with the split raw water stream—see FIG. 3, and NaOH dosage of 13.1 mg/L) is: Alkalinity=67 mg/L as CaCO₃, [Ca²⁺]=81 mg/L as CaCO₃, [Mg²⁺]=12.15 mg/L, pH=8.44 and CCPP=3.0 mg/L as CaCO₃.

Estimation of the Volume of Resin Required in the Multiple Column Ion Exchange Process (According to the Requirements Presented in this Example)

Using the same resin and flow rates as in example #1, the volume of resin in the Exchange step should also be the same, i.e. around 100 m³ (see example #1).

The time a resin column spends in the “Load” step in this example is less than 7% of the time it spends in the “Exchange” step. The time a resin column spends in the “Wash” step in this example is expected not to exceed 2% of the time it spends in the “Exchange” step. Therefore, the volume of resin required in the load and wash steps together amounts to around 9% of the amount in the exchange step. Thus, a total volume of 110 m³ resin is required in this example.

Accordingly, a typical design can assume 11 ion exchange columns, each with 10 m³ of resin: at all times 10 columns would be in the exchange step while the 11^{th} column would be in the load/wash step. A single ion exchange column will produce water at the beginning of the exchange step that is high in Mg²⁺ and low in Ca²⁺ and exactly the opposite at the end of the exchange step. However, under the suggested design, the 10 resin columns are operated at a time gap of 37 min from each other. (The “Exchange step” lasts 220 BV at a flow rate of 35 BV/h, i.e. a full cycle of single column would last 6.29 h and one-tenth of it is 37 min). Under such an operational regime, the effluents of the ion exchange columns are mixed and the Mg²⁺ and Ca²⁺ concentrations in the final product water would change linearly with time during 37 min repeating cycles from 7.53 to 8.34 meq/L ([Ca²]) and from 4.54 to 3.56 meq/L ([Mg²⁺]).

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. An H₂SO₄-based calcite dissolution post-treatment process for desalinated water comprising:
separating cations from natural water body by means of at least one type of ion exchange resin onto which said cations are loaded; and
contacting said at least one ion exchange resin loaded with said cations with an effluent of a calcite reactor wherein said cations are exchanged with Ca²⁺ from said effluent,
whereby the Ca²⁺ concentration of the resulting desalinated water decreases while the cation concentration increases to comply with required quality criteria.

2. The process as claimed in claim 1, which further comprises washing said ion exchange resin with an internal desalination-plant water stream low in dissolved solids.

3. The process as claimed in claim 1, wherein said cations are Mg²⁺, K⁺ and Na⁺ and wherein Mg²⁺ ions are being exchanged in a first type ion exchange resin and Na⁺ and K⁺ ions in a second type ion exchange resin.

4. The process as claimed in claim 3, wherein said first type ion exchange resin has a high affinity towards divalent cations such as Mg²⁺ and Ca²⁺ and an extremely low affinity towards monovalent cations such as Na⁺ and K⁺.

5. The process as claimed in claim 3, wherein said second type ion exchange resin has a high affinity towards monovalent cations such as Na⁺ and K⁺ and a relatively low affinity towards divalent cations such as Ca²⁺ and Mg²⁺.

6. The process as claimed in claim 4, wherein said first type ion exchange resin is a resin such as Amberlite IRC747 or an equivalent.

7. The process as claimed in claim 1, wherein said seawater used to load the resin with cations is filtered seawater before it enters a desalination process.

8. The process as claimed in claim 7, wherein the seawater used to load the resin with said cations is pre-filtered using sand filtration or UF membranes.

9. The process as claimed in claim 1, wherein said seawater used to load the resin with said cations is a brine stream provided from a desalination process.

10. The process as claimed in claim 7, wherein said seawater that is used to load the resins is returned to a container from where it was taken in a closed loop manner, or discarded back to the sea in case brine is used to load the resins.

11. The process as claimed in claim 1, wherein the process is carried out in a batch ion-exchange mode.

12. The process as claimed in claim 1, wherein the process is carried out in a continuous ion exchange mode.

13. The process as claimed in claim 1, wherein the required quality criteria is Alkalinity (H₂CO₃* alkalinity) greater than 60 mg/L as CaCO₃; Ca²⁺ higher than 80 mg/L; Calcium Carbonate Precipitation Potential between 3 and 10 mg/L as CaCO₃ and pH of less than 8.5.

14. The process as claimed in claim 1, wherein the process can be implemented in order to replace any certain fraction of the Ca²⁺ concentration generated by H₂SO₄-based calcium by an equivalent cations concentrations.

15. A post-treatment apparatus for treating water coming out of a desalination process comprising:
at least one ion exchange column provided with a resin wherein the resins are capable of loading cations in at least one load cycle and capable of exchanging a portion of said cations with Ca²⁺ ions in at least one ion exchange cycle; and
a calcite reactor adapted to provide said Ca²⁺ ions that are being transferred from said calcite reactor to said at least one ion exchange column in said exchange cycle,
whereby the resulting desalinated water coming out of the exchange cycle is lower in Ca²⁺ concentration and richer in said cations (relative to the water leaving said calcite reactor) so as to comply with required quality criteria or in order to add cations to the water at the expense of Ca²⁺ ions.

16. The apparatus as claimed in claim 15, wherein said cations are Mg²⁺, Na⁺ and K⁺.

17. The apparatus as claimed in claim 15, which further comprises means capable of washing said at least one ion exchange column and return wash water back to a point in the desalination process from which it was taken or discard it to the sea.

18. The apparatus as claimed in claim 15, wherein effluent from said ion exchange cycles is recombined with raw water split flow of the desalinated water and NaOH is added to the combined flow to attain desalinated water having predetermined required pH, alkalinity, Ca²⁺, other cations, total hardness and CCPP values.

19. The apparatus as claimed in claim 18, wherein the water added with NaOH is mixed in a storage tank to yield a required water quality prior to discharge.

20. The apparatus as claimed in claim 15, wherein said ion exchange column is a continuous exchanger wherein said resin is adapted to pass between a “load zone”; a “wash zone”; and an “exchange zone” and wherein the time the resin spends in each of the zones is determined by specific required quality criteria.

21. The apparatus as claimed in claim 15, wherein a first resin of the resins is a resin selected from a group of resins such as Amberlite IRC747.

22. The apparatus as claimed in claim 15, wherein said cations are originating from filtered seawater before it enters the desalination process or from brine provided from a desalination process.

23. The apparatus as claimed in claim 22, wherein said cations are Mg²⁺, Na⁺ and K⁺.

24. The apparatus as claimed in claim 22, wherein said filtered seawater or brine is returned to a container from where it was taken in a closed loop manner or discarded to the sea after passing through said at least one ion exchange column.

25. (canceled)

26. (canceled)
